(19) United States
(12) Patent Application Publication
(10) Pub. No.: US 2026/0339898 A1
(43) Pub. Date: Oct. 29, 2026

(54) DATA SYNCHRONIZATION METHOD FOR FILE SYSTEM

(71) Applicant: SAMSUNG ELECTRONICS CO., LTD., Suwon-si (KR)

(72) Inventors: Sangheon LEE, Suwon-si (KR); Junhee LEE, Suwon-si (KR); Seungwoo LEE, Suwon-si (KR)

(73) Assignee: SAMSUNG ELECTRONICS CO., LTD., Suwon-si (KR)

(21) Appl. No.: 19/642,206

(22) Filed: Apr. 8, 2026

(30) Foreign Application Priority Data
Apr. 28, 2025 (KR) 10-2025-0055342
Sep. 22, 2025 (KR) 10-2025-0136461

(51) Int. Cl. G06F 16/178

(52) U.S. Cl. CPC G06F 16/178

(57) ABSTRACT

A data synchronization method between a source database (DB) and a file system, includes receiving, by a first agent server, a log file generated by a DB server managing the source DB; generating, by the first agent server, a plurality of change data capture (CDC) messages for CDC, based on the log file; selecting, by a second agent server, at least one CDC message, from among the plurality of CDC messages; loading, by the second agent server, data into the file system managed by a target server, based on the at least one CDC message that is selected; and optimizing, by the second agent server, the data loaded into the file system.

### CROSS-REFERENCE TO RELATED APPLICATION(S)

This application claims priority to Korean Patent Application No. 10-2025-0055342 filed on Apr. 28, 2025, and Korean Patent Application No. 10-2025-0136461 filed on Sep. 22, 2025, in the Korean Intellectual Property Office, the disclosures of which are incorporated by reference herein in their entireties.

### BACKGROUND

The present disclosure relates to a data synchronization method for a file system.

In a database (DB) managing a large amount of data stored on a server, an operation of migrating or copying data changes occurring in the DB to another server may be performed. A change data capture (CDC) technology may be used for an operation of reflecting data changes occurring in the DB in another storage. The CDC technology may maintain data integrity and synchronize data stored in different storages. However, a CDC-based data synchronization method according to the related art may reflect data changes of a source DB in a target DB, and a method of reflecting data changes occurring in a DB to a file system has not been proposed in the related art.

### SUMMARY

An aspect of the present disclosure is to provide a data synchronization method capable of rapidly synchronizing data in real time between a database (DB) and a file system by converting a log file in which data changes occurring in the DB are recorded into a change data capture (CDC) message, selecting a valid CDC message, and loading, based on the valid CDC message, data into the file system.

According to an aspect of the disclosure, a data synchronization method between a source database (DB) and a file system, includes: receiving, by a first agent server, a log file generated by a DB server managing the source DB; generating, by the first agent server, a plurality of change data capture (CDC) messages for CDC, based on the log file; selecting, by a second agent server, at least one CDC message, from among the plurality of CDC messages, as valid CDC message; loading, by the second agent server, data into the file system managed by a target server, based on the at least one CDC message that is selected; and optimizing, by the second agent server, the data loaded into the file system.

According to an aspect of the disclosure, a system includes: a database (DB) server configured to manage a source DB; a target server configured to manage a file system in which one or more data changes occurring in the source DB by a data manipulation language executed by the DB server are reflected; and an agent server configured to receive a log file generated by the DB server, generate a plurality of change data capture (CDC) messages, select at least one CDC message from the plurality of CDC messages, as valid CDC message, and generate, based on the at least one CDC message that is selected, a structured query language (SQL) query for reflecting the one or more data changes in the file system.

According to an aspect of the disclosure, a change data capture (CDC)-based data synchronization method includes: receiving a log file from a source server in which one or more data changes occur in response to a data manipulation language; converting the log file into a plurality of CDC messages; selecting at least one CDC message, from the plurality of CDC messages, as valid CDC message; and loading the one or more data changes into a target server based on the at least one CDC message that is selected, in which the source server is configured to store data in a source DB, and the target server is configured to store data in a file system.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic diagram illustrating a system in which a data synchronization method for a file system is executed according to one or more example embodiments of the present disclosure;

FIG. 2 is a flowchart illustrating a data synchronization method for a file system according to one or more example embodiments of the present disclosure;

FIG. 3 is a sequence diagram illustrating a data synchronization method for a file system according to one or more example embodiments of the present disclosure;

FIG. 4 is a diagram illustrating execution of a data synchronization method for a file system according to one or more example embodiments of the present disclosure;

FIG. 5 is a flowchart illustrating a data synchronization method for a file system according to one or more example embodiments of the present disclosure;

FIG. 6 is a diagram illustrating a data synchronization method for a file system according to one or more example embodiments of the present disclosure;

FIGS. 7, 8, and 9 are diagrams illustrating a data synchronization method for a file system according to one or more example embodiments of the present disclosure; and

FIGS. 10, 11, 12, and 13 are diagrams illustrating execution of a data synchronization method for a file system according to one or more example embodiments of the present disclosure.

### DETAILED DESCRIPTION

Hereinafter, example embodiments of the present disclosure will be described with reference to the accompanying drawings as follows.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

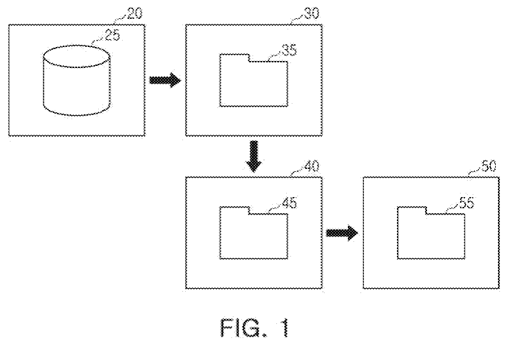

FIG. 1 is a schematic diagram illustrating a system in which a data synchronization method for a file system is executed according to one or more example embodiments of the present disclosure.

Referring to FIG. 1, a system 10 according to one or more example embodiments of the present disclosure may include a plurality of servers 20, 30, 40, and 50. A first server 20 may be a database (DB) server structuring data and managing the data in a DB 25. The DB 25 may be managed by a database management system (DBMS). The DBMS may interpret an SQL query written by an administrator of the first server 20 or by an application, and may manage the DB 25 according to the SQL query. For example, the SQL query may include one or more data manipulation languages (DML). Each of the DML instructions or operations may instruct data insertion (INSERT), data update (UPDATE), data deletion (DELETE), or the like. For example, the one or more DML instructions or operations may be processed as a single transaction.

Second, third, and fourth servers 30, 40, and 50 may manage files in which data is recorded in file systems 35, 45, and 55, respectively. The second server 30 and the third server 40 may be servers for implementing data synchronization between the first server 20, providing the source DB 25, and the fourth server 50, a target server. In one or more example embodiments, the second server 30 and the third server 40 may provide different functions, and the second server 30 and the third server 40 may be integrated into and implemented as a single server. In one or more examples at least one of the second server 30 and the third server 40 may be implemented as a cluster of a plurality of servers.

In one or more example embodiments, when data changes occur in the source DB 25 due to a DML included in a transaction executed by the first server 20, the first server 20 may generate a log file in response to the data change. For example, the log file may be generated by a DBMS of the first server 20. The log file may include a redo log for redoing the data changes and an undo log for undoing the data changes in case of a transaction failure. For example, a redo log may result in repeating an instruction, and an undo log may result in undoing an instruction by removing or reversing a result of the instruction. The first server 20 may be defined as a source server managing the source DB 25 in which the data changes occur.

For example, the log file may be generated before data changes, caused by a DML included in a transaction, are actually reflected in the source DB 25. When a DML is input to the first server 20, the DBMS may first generate a redo log and/or an undo log corresponding to the input DML, and may then change data of the source DB 25 according to the input DML. Accordingly, when a failure, error, or fault occurs during the data change, the source DB 25 may be restored to a latest state by sequentially applying the redo log, or an incomplete transaction may be rolled back based on the undo log.

A log generated by the DBMS of the first server 20 may be converted into a log file and transmitted to the second server 30. The second server 30 may be defined as a first agent server. For example, the second server 30 may receive a log file generated in a binary format from the first server 20, and the log file received by the second server 30 may include a transaction log corresponding to data changes due to the DML input to the first server 20.

The second server 30 may be an agent server executing a change data capture (CDC) framework. The CDC framework may convert a log file in which data changes occurring in the source DB 25 of the first server 20 is recorded into a different format and transmit the converted log file to another external server, for example, the third server 40. For example, as described above, the DBMS of the first server 20 may generate a log file in a binary format with reference to a transaction log, and may transmit the log file to the second server 30.

The CDC framework executed by the second server 30 may extract a DML instructions or operation causing data changes from a log file having a binary format, and may change the extracted DML into a CDC message having a different format such as JavaScript Object Notation (JSON). When the second server 30 receives a transaction log in which data changes of the source DB 25 are recorded as a log file, the CDC framework may extract a DML instruction or operation such as data insertion (INSERT), data update (UPDATE), or data deletion (DELETE) included in the log file, and may change the DML into a CDC message having a different format. For example, the number of CDC messages generated by the CDC framework may be determined according to the number of DML instructions or operations included in the log file. The second server 30 may operate a storage storing log files and CDC messages, based on the file system 35.

The third server 40 may be a server, receiving and processing CDC messages generated by the CDC framework of the second server 30, and may be defined as a second agent server. The third server 40 may select valid CDC messages from among the CDC messages generated by the CDC framework. The valid CDC messages may be selected from among the CDC messages generated by the CDC framework, thereby reducing an amount of data transmitted by the third server 40 to the fourth server 50, and reducing a load of the fourth server 50 in a process of loading data. The third server 40 may operate the CDC messages and the valid CDC messages, based on the file system 45.

For example, when it is assumed that data changes occur in the source DB 25 such that data corresponding to a single primary key is inserted (INSERT) and a portion of the data is modified by an update (UPDATE), changes corresponding to the insertion and the update may be recorded in the log file as redo logs. In one or more examples the CDC framework of the second server 30 may generate CDC messages for the insertion and update, such that a first CDC message corresponding to the insertion and a second CDC message corresponding to the update may be generated by the CDC framework.

A CDC platform for determining a valid CDC message, among the first CDC message and the second CDC message, may be implemented in the third server 40, and the CDC platform may determine the valid CDC message with reference to a file system 55 of the fourth server 50, a destination for data loading, and may generate, based on the valid CDC message, a query executable by the fourth server 50. For example, in the assumed case above, the third server 40 may select the second CDC message as the valid CDC message. However, a query generated by the CDC platform of the third server 40 may vary depending on whether data corresponding to the primary key is present in the file system 55 of the fourth server 50.

For example, when data corresponding to the primary key is present in the file system 55 of the fourth server 50, the third server 40 may generate a query instructing an update operation included in the second CDC message. Conversely, in the assumed example above, when the data corresponding to the primary key is not present in the file system 55 of the fourth server 50, the third server 40 may generate a query instructing an insertion (INSERT) operation by allowing data included in the second CDC message to match the primary key.

As described above, the data changes of the source DB 25 may be applied to the file system 55 of the fourth server 50, a target server. Accordingly, the file system 55 may be managed in synchronization with the source DB 25. However, due to characteristics of the file system 55 different from a DB, a data synchronization operation may be repeatedly executed, such that a large number of files may be generated in the file system 55. Accordingly, in one or more embodiments of the present disclosure, the fourth server 50 may generate a management table or the like for managing versions of data recorded in individual files, and may execute an optimization operation for deleting an expired file and merging some files with reference to the management table.

In one or more embodiments, the fourth server 50, a target server, may include a framework configured to manage files stored in the file system 55 in the same manner as a DB table. The framework included in the fourth server 50 may generate a management table for managing versions of data recorded in individual files. For example, the fourth server 50 may manage files stored in the file system 55 using a table format such as an Apache Iceberg framework.

In the example embodiment described with reference to FIG. 1, the first server 20 may transmit, to the second server 30, a log file generated in the process of executing a DML input thereto and changing data of the source DB 25. The second server 30 may convert the log file into CDC messages having a format such as JSON, and may transmit the CDC messages to the third server 40, and the third server 40 may select valid CDC messages from among the CDC messages. The third server 40 may instruct the fourth server 50, a target server, to load data, such that the data changes of the source DB 25 may be loaded into the file system 55 of the fourth server 50.

Accordingly, in one or more example embodiments of the present disclosure, a data change, caused by an operation such as insertion (INSERT), update (UPDATE), or deletion (DELETE) executed in the source DB 25 by a DML, may be reflected in the file system 55 with minimized delay. During execution of the DML, the second server 30 may externally read a log file generated by the first server 20, and may convert the log file into CDC messages. The third server 40 may select only a valid CDC message, among the CDC messages, and may reflect the valid CDC message in the file system 55 of the fourth server 50, a target server, such that the data changes of the source DB 25 may be loaded into the file system 55 of the fourth server 50 while minimizing data latency.

In some example embodiments, the second server 30 and/or the third server 40 may collect CDC messages generated during a predetermined period and process the CDC messages together. In one or more examples, depending on performance of a query engine and/or a storage on which the file system 55 is executed, CDC messages corresponding to a DML may be generated whenever data changes occur in the source DB 25, and a valid CDC message may be retrieved and loaded into the file system 55.

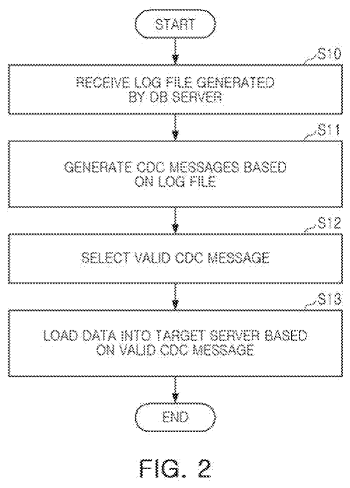

FIG. 2 is a flowchart illustrating a data synchronization method for a file system according to one or more example embodiments of the present disclosure.

Referring to FIG. 2, a data synchronization method according to one or more example embodiments of the present disclosure may start with an agent server receiving a log file generated by a DB server (S10). As described above with reference to FIG. 1, the agent server may be implemented as an entity separate from the DB server, and data of the DB server may be changed in the process of processing a DML generated by a user, an application, or the like. A DBMS of the DB server may generate a redo log, an undo log, and/or the like, before finally changing the data by processing the DML. The log file received by the agent server in operation S10 may be a file in which the log generated as described above is recorded in a binary format, or the like.

The agent server may generate CDC messages, based on the log file (S11). The agent server may convert DML instruction or operation recorded in the log file into a CDC message having a format different from that of the log file by executing a CDC framework. For example, the CDC framework of the agent server may convert a DML instruction or operation recorded in binary format in the log file into a CDC message having a JSON format. However, the format of the CDC message is not limited to JSON, and the CDC message may be generated in another format such as Avro.

When the CDC message is generated, a valid CDC message may be selected (S12). For example, when a plurality of DML instructions or operations are input to a DB server and data changes occur, the data changes by the plurality of DML instructions or operations may be recorded in the log file received by the agent server. Accordingly, the agent server may generate a plurality of CDC messages corresponding to the plurality of DML instructions or operations input to the DB server in operation S11.

In operation S12, a valid CDC message may be selected from among the plurality of CDC messages generated in operation S11. The number of valid CDC messages selected in operation S12 may vary depending on example embodiments. For example, the agent server selecting the valid CDC message may be implemented as an entity separate from the agent server generating the CDC messages, based on the log file. The system may have improved stability by implementing the agent server generating the CDC messages and the agent server selecting the valid CDC message as separate entities. For example, among the plurality of CDC messages generated in operation S11, when there are two or more CDC messages corresponding to a single primary key, only a latest CDC message may be selected as a valid CDC message. In one or more examples, a valid CDC message may be a CDC message that meets a predetermined condition such as being generated within a predetermined period of time or being a most recently generated CDC message in a sequence of CDC messages.

The agent server selecting the valid CDC message may load data into a target server, based on the valid CDC message (S13). When loading of data executed in operation S13 is completed, data changes occurring in a source DB managed by the DB server may be reflected in a file system of the target server. Accordingly, the file system of the target server may be synchronized with the source DB. For example, the agent server selecting the valid CDC message may generate a query through which the file system may store data based on the valid CDC message.

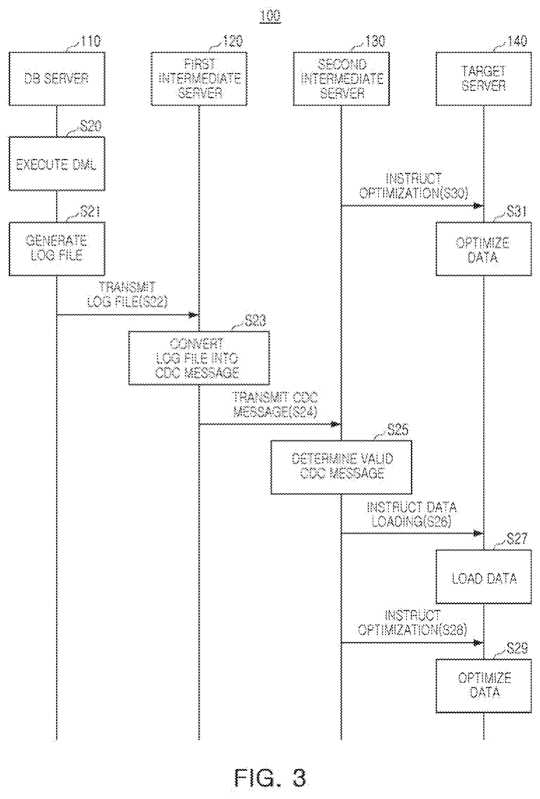

FIG. 3 is a sequence diagram illustrating a data synchronization method for a file system according to one or more example embodiments of the present disclosure.

Referring to FIG. 3, a data synchronization method according to one or more example embodiments of the present disclosure may be executed in a system 100 including a DB server 110, a first intermediate server 120, a second intermediate server 130, and a target server 140. The DB server 110 may be a server managing and operating a source DB in which data changes occur, and the target server 140 may be a server extracting and loading the data changes of the source DB. The target server 140 may load the data changes of the source DB into a file system other than a DB.

The first intermediate server 120 and the second intermediate server 130 may be, respectively, an agent server, and may be implemented as entities independent of the DB server 110 and the target server 140. In one or more example embodiments illustrated in FIG. 3, the first intermediate server 120 and the second intermediate server 130 may be implemented as independent entities. In one or more examples, the first intermediate server 120 and the second intermediate server 130 may be implemented as a single entity.

Referring to FIG. 3, a DML may be executed in the DB server 110 (S20). The DML may be input to a DBMS executed in the DB server 110 in the form of an SQL query or the like, and the DBMS may interpret the SQL query and change data recorded in the DB. However, before changing the data by executing a command according to the DML, the DBMS may generate a redo log and an undo log, and may generate a log file in which a log is recorded (S21). In one or more example embodiments, the DBMS may generate a log file in a binary format.

The log file generated by the DB server 110 may be transmitted to the first intermediate server 120 (S22). The first intermediate server 120 may execute a CDC framework to convert the received log file into a CDC message (S23). The CDC message may have a format different from the binary format of the log file, and the CDC framework of the first intermediate server 120 may generate a CDC message in a format such as JSON, Avro, Thrift, or the like.

In operation S23, a plurality of CDC messages may be generated. For example, the DB server 110 may process a plurality of DML instructions or operations transmitting individual commands on a transaction basis. During processing of a transaction, a log file may be generated. When the transaction includes a plurality of DML instructions or operations, the log file may record data changes corresponding to the plurality of DML instructions or operations. The first intermediate server 120 may generate CDC messages respectively corresponding to the data changes recorded in the log file. The first intermediate server 120 may then transmit the CDC messages generated in operation S23 to the second intermediate server 130 (S24).

The second intermediate server 130 may determine valid CDC messages by processing the CDC messages received in operation S24 (S25). For example, the second intermediate server 130 may determine the valid CDC messages by arranging the CDC messages in chronological order and selecting a latest CDC message corresponding to each primary key of the source DB. In one or more example embodiments, the second intermediate server 130 may select a single valid CDC message for a single primary key.

When the valid CDC messages are selected, the second intermediate server 130 may instruct the target server 140 to load data (S26). As data loading based on the valid CDC messages is instructed, the target server 140 may load data into the file system (S27). Accordingly, the data changes of the source DB managed by the DB server 110 may be reflected in the file system managed by the target server 140, and the source DB of the DB server 110 and the file system of the target server 140 may be synchronized with each other.

The second intermediate server 130 may instruct the target server 140 to optimize data (S28). The data changes of the source DB may be reflected in the file system of the target server 140. Accordingly, as a data loading operation according to operations S20 to S27 is repeatedly executed, multiple files may be generated in the target server 140. The target server 140 may improve storage space efficiency and remove unnecessary files by executing an optimization operation (S29). For example, when an optimization instruction is received from the second intermediate server 130, the target server 140 may execute an operation of deleting expired files based on metadata or the like, or may execute an operation of merging two or more files having small capacities. For examples, two or more files having a file size below a file size threshold may be merged together. In one or more examples the target server 140 may improve storage space efficiency by compressing and storing files.

The optimization operation described above may be executed regardless of the data loading operation. The second intermediate server 130 may operate as an agent server for the target server 140. As illustrated in FIG. 3, the second intermediate server 130 may instruct the target server 140 to execute the optimization operation separately from the data loading operation (S30). In response thereto, the target server 140 may execute the optimization operation (S31). For example, the second intermediate server 130 may instruct the target server 140 to execute the optimization operation at a predetermined interval.

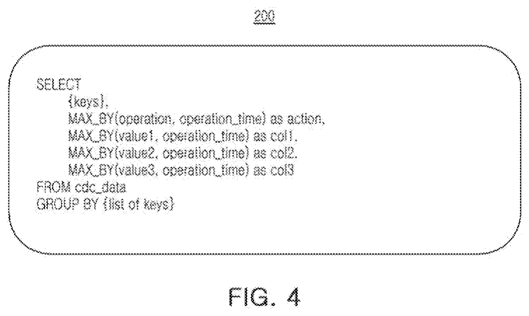

FIG. 4 is a diagram illustrating execution of a data synchronization method for a file system according to one or more example embodiments of the present disclosure.

In one or more example embodiments of the present disclosure, a first intermediate server, receiving a log file from a DB server managing a source DB, may generate CDC messages, based on data changes recorded in a log file. A second intermediate server may select valid CDC messages from among the CDC messages generated by the first intermediate server. FIG. 4 illustrates one or more examples of a query 200 for selecting valid CDC messages from among the CDC messages generated by the first intermediate server.

The query 200 illustrated in FIG. 4 may be executed on a CDC platform of the second intermediate server. The CDC platform may include a message queue (QUEUE) configured to store CDC messages. As described above, a DML, changing data corresponding to a single primary key stored in the source DB, may be input two or more times, such that a DML, most recently changing data based on the primary key, may be selected to determine valid CDC messages.

Referring to FIG. 4, a column corresponding to a primary key in a table may be selected through a SELECT statement. Subsequently, using a MAX_BY function, an operation having a largest execution point in time (operation_time) of each of data changes corresponding to a single primary key selected in the SELECT statement may be stored in an operation column (action). By the MAX_BY function, information indicating a most recently executed data change operation may be stored in a result column named action. Assuming that an insertion (INSERT) operation is executed at a first point in time for a first primary key and an update (UPDATE) operation is executed at a second point in time after the first point in time, the update (UPDATE) operation may be recorded in an operation column (action) corresponding to the first primary key.

Subsequently, values (value1, value2, and value3) corresponding to the update (UPDATE) operation, executed at the second point in time, may be recorded in first, second, and third columns (col1, col2, and col3), respectively. In the above example, the update (UPDATE) operation may be recorded in an operation column (action) corresponding to the first primary key, a first value (value1) may be recorded in a first column (col1) corresponding to the first primary key, a second value (value2) may be recorded in a second column (col2), and a third value (value3) may be recorded in a third column (col3).

TABLE 1

| Primary key | operation | operation_time | value1 | value2 | value3 |
|---|---|---|---|---|---|
| PK1 | INSERT | 2025 Jan. 1 | KIM | 31 | BUSAN |
| PK1 | UPDATE | 2025 Jan. 8 | KIM | 32 | SEOUL |

TABLE 2

| Primary key | action | col1 | col2 | col3 |
|---|---|---|---|---|
| PK1 | UPDATE | KIM | 32 | SEOUL |

Table 1 illustrates one or more examples of CDC messages generated by the first intermediate server, and Table 2 illustrates one or more examples of valid CDC messages selected from among the CDC messages by the second intermediate server. Referring to Tables 1 and 2, it can be seen that an insertion (INSERT) operation for data corresponding to a single first primary key (PK1) and an update (UPDATE) operation for the data corresponding to the first primary key (PK1) were executed in the source DB.

When a query is executed as illustrated in FIG. 4, an operation having a largest execution point in time (operation_time), indicating a point in time at which data is changed, may be selected from among the CDC messages, and may be stored in an operation column (action) of the valid CDC message. In Table 1, an update (UPDATE) operation having a largest execution point in time (operation_time) may be stored in the operation column (action) of Table 2.

In the example embodiment illustrated in Table 1, the first value (value1) may indicate a name of a customer, the second value (value2) may indicate an age of the customer, and the third value (value3) may indicate a residence of the customer. By the query illustrated in FIG. 4, the first, second, and third values (value1, value2, and value3) corresponding to the largest execution point in time (operation_time) may be selected and stored in the first, second, and third columns (col1, col2, and col3) of the valid CDC message. Accordingly, “KIM,” “32,” and “SEOUL” may be respectively stored in the first, second, and third columns (col1, col2, and col3) of the valid CDC message.

In the example embodiment described with reference to FIG. 4 and Tables 1 and 2, Table 1 may correspond to cdc_data in the query illustrated in FIG. 4. When the valid CDC message selected by the second intermediate server are configured as a plurality of the valid CDC messages, the second intermediate server may group the valid CDC messages in response to a GROUP_BY clause of the query.

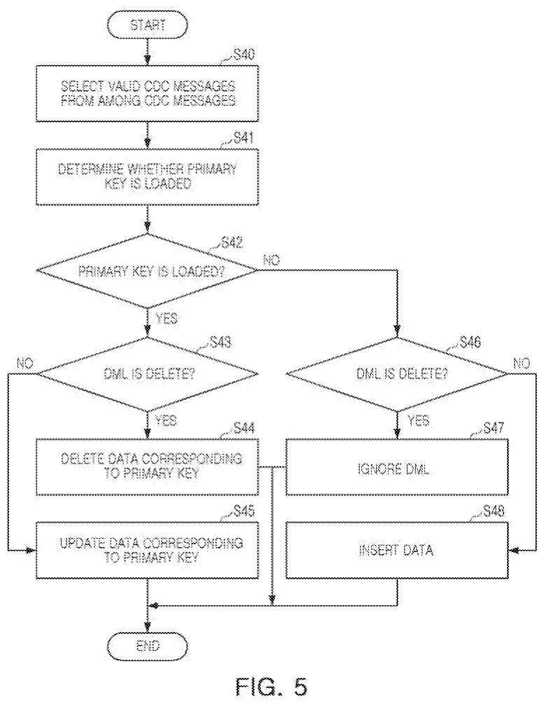

FIG. 5 is a flowchart illustrating a data synchronization method for a file system according to one or more example embodiments of the present disclosure.

The data synchronization method described with reference to FIG. 5 may be executed on an agent server of a target server into which data changes of a source DB are loaded. First, the agent server may select valid CDC messages from among a plurality of CDC messages (S40). The agent server may receive CDC messages generated from a log file generated by a DB server managing the source DB, and may select valid CDC messages from among the CDC messages. A process of selecting the valid CDC messages may be understood based on the example embodiment described with reference to FIG. 4.

When the valid CDC messages are selected, the agent server may determine whether a primary key recorded in each of the valid CDC messages is loaded into a file system of the target server (S41). A type of operation actually executed on the target server in response to an operation recorded in each of the valid CDC messages may vary depending on whether the primary key is loaded into the file system of the target server.

For example, when it is determined that a primary key recorded in a single valid CDC message is loaded into the file system of the target server (S42), the agent server may determine whether an DML indicated by an operation recorded in the valid CDC message is a deletion (DELETE) operation (S43). When it is determined that the DML is the deletion (DELETE) operation in operation S43, the agent server may delete data corresponding to the primary key recorded in the valid CDC message from the file system of the target server (S44). When it is determined that the DML is not the deletion (DELETE) operation in operation S43, the agent server may update existing data corresponding to the primary key recorded in the file system of the target server, using data corresponding to the primary key recorded in the valid CDC message.

Subsequently, when it is determined that a primary key recorded in a single valid CDC message is not loaded into the file system of the target server (S42), the agent server may determine whether a DML indicated by an operation recorded in the valid CDC message is a deletion (DELETE) operation (S46). When it is determined that the DML is the deletion (DELETE) operation in operation S46, the agent server may ignore the DML corresponding to the valid CDC message and may not instruct any operation on the target server (S47). For example, operation S47 may be executed, when a DML, inserting (INSERT) data for a specific primary key, is first input to the source DB, and subsequently a DML, deleting (DELETE) the data for the primary key, is input.

When it is determined that the DML is not the deletion (DELETE) operation in operation S46, the agent server may instruct the target server to perform an insertion (INSERT) operation for adding the primary key and data recorded in the valid CDC message (S48). Accordingly, the target server may generate a new file in which the primary key and data recorded in the valid CDC message are recorded, and may store the new file in the file system.

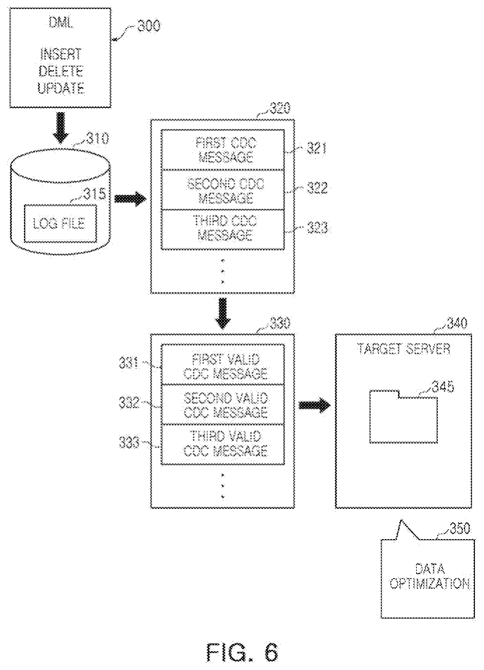

FIG. 6 is a diagram illustrating a data synchronization method for a file system according to one or more example embodiments of the present disclosure.

Referring to FIG. 6, a DML 300 may be input to a source DB 310. The DML 300 may include one or more commands, such as insertion (INSERT), update (UPDATE), or deletion (DELETE), which cause data changes in the source DB 310. A DBMS, managing the source DB 310, may generate a log file 315 in response to the input DML 300.

When the log file 315 is generated, a first agent server 320, separate from the source DB 310, may receive the log file 315 and convert the log file 315 into a plurality of CDC messages 321 to 323. The plurality of CDC messages 321 to 323 may be generated by a CDC framework executed on the first agent server 320. For example, the DBMS may transmit, to the first agent server 320, the log file 315 corresponding to a DML input to the source DB 310 during a predetermined period of time.

The first agent server 320 may transmit the plurality of CDC messages 321 to 323 to a second agent server 330. The second agent server 330 may select valid CDC messages 331 to 333 from among the plurality of CDC messages 321 to 323. For example, the number of the plurality of CDC messages 321 to 323 may be equal to the number of times the source DB 310 changes data in response to the DML 300. For example, the number of the plurality of CDC messages 321 to 323 may be equal to the number of commands included in the DML 300 and causing a data change.

The second agent server 330 may select some CDC messages from among the plurality of CDC messages 321 to 323 as valid CDC messages 331 to 333. Based on the valid CDC messages 331 to 333, the second agent server 330 may load data changes occurring in the source DB 310 into a file system 345 of a target server 340. The data changes of the source DB 310 may be loaded into the file system 345 based on the valid CDC messages 331 to 333 selected from among the plurality of CDC messages 321 to 323, rather than the plurality of CDC messages 321 to 323, thereby reducing a load of the target server 340 managing the file system 345, and efficiently managing a storage space of the file system 345.

The target server 340 may execute a data optimization operation 350 separately from data loading. The data optimization operation 350 may be instructed by the second agent server 330. In some example embodiments, the data optimization operation 350 may be instructed by a server implemented as an entity separate from the second agent server 330. In the data optimization operation 350, an expired file may be deleted, small-capacity files may be merged, and files may be compressed and stored.

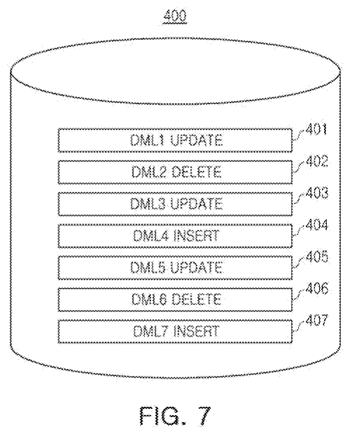

FIGS. 7, 8, and 9 are diagrams illustrating a data synchronization method for a file system according to one or more example embodiments of the present disclosure.

FIG. 7 is an example diagram illustrating commands respectively included in DML instructions or operations 401 to 407 input to a DB server managing a source DB 400. Referring to FIG. 7, a portion of data existing in the source DB 400 may be changed by a first DML 401, and a portion of data existing in the source DB 400 may be deleted by a second DML 402. Data not existing in the source DB 400 may be added by a fourth DML 404.

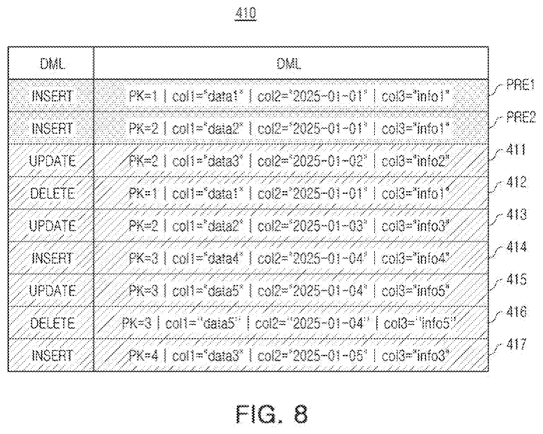

FIG. 8 is an example diagram illustrating CDC messages 410 (411 to 417) generated by a CDC framework in response to DML instructions or operations 401 to 407 input to a DB server managing the source DB 400. In the example embodiment described with reference to FIGS. 7 and 8, the source DB 400 may retain data stored before the DML instructions or operations 401 to 407 are input. In the example embodiment illustrated in FIG. 8, two previous CDC messages PRE1 and PRE2 may be CDC messages generated by the CDC framework in response to log files generated from DML instructions or operations input to the DB server prior to the DML instructions or operations 401 to 407 illustrated in FIG. 7. Referring to FIG. 8, each of the DML instructions or operations, causing generation of the two previous CDC messages, may instruct an insertion (INSERT) operation for adding new data to the source DB 400.

Referring to FIG. 8, as represented by the previous CDC messages PRE1 and PRE2, in a state in which data corresponding to a first primary key and data corresponding to a second primary key are stored in the source DB 400, DML instructions or operations 401 to 407 may be input to the DB server managing the source DB 400. For example, before the DML instructions or operations 401 to 407 are input to and executed by the DB server, the source DB 400 may store data as illustrated in Table 3 below.

TABLE 3

| Primary key (PK) | col1 | col2 | col3 |
|---|---|---|---|
| 1 | data1 | 2025 Jan. 1 | info1 |
| 2 | data2 | 2025 Jan. 1 | info1 |

Referring to Table 3, specific data may be recorded in a first column col1, specific information may be recorded in a third column col3, and a point in time at which the data is input may be recorded in a second column col2. In the example embodiment illustrated in FIG. 8, the data corresponding to the first primary key and the data corresponding to the second primary key may be regarded as recorded on the same date. In some example embodiments, the source DB 400 may record data, based on a unique index, without a primary key PK.

When DML instructions or operations 401 to 407 are input to the DB server managing the source DB 400 in a state in which data illustrated in Table 3 is recorded in the source DB 400, the DB server managing the source DB 400 may generate a log file, based on the DML instructions or operations 410. Here, the log file may include a redo log. FIG. 8 may illustrate data changes history according to each of the DML instructions or operations 410. For example, after a command instructed by each of the DML instructions or operations 410 is executed in the DB server, data illustrated Table 4 below may be recorded in the source DB 400.

TABLE 4

| Primary key (PK) | col1 | col2 | col3 |
|---|---|---|---|
| 2 | data2 | 2025 Jan. 3 | info3 |
| 4 | data3 | 2025 Jan. 5 | info3 |

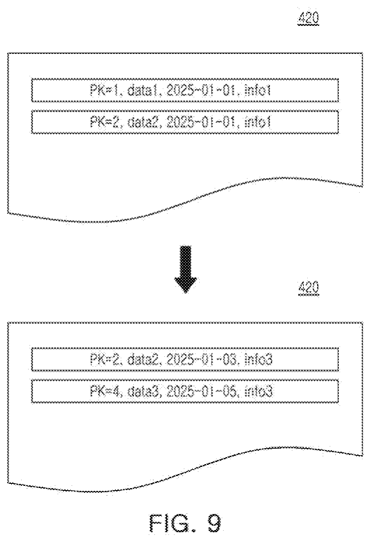

Data to be loaded into a file system of a target server through data synchronization may be latest data stored in the source DB 400, as illustrated in Table 4 above. Referring to FIG. 9, before an agent server executes a data loading operation, the data illustrated in Table 3 may be stored in a file system 420. Thereafter, the agent server may execute the data loading operation, such that the data illustrated in Table 4 may be stored in the file system 420.

Hereinafter, an operation of selecting valid CDC messages from among a plurality of CDC messages 410 generated from a plurality of DML instructions or operations 410 will be described with reference to FIG. 8.

An operation of selecting valid CDC messages may start with selecting CDC messages having the same primary key PK. When the CDC messages having the same primary key PK are selected, among the selected CDC messages, an operation having a largest data changes point in time, that is, an operation having a latest data change point in time, may be recorded in an operation column corresponding to the primary key PK.

For example, in the example embodiment illustrated in FIG. 8, when a first CDC message 411 and a third CDC message 413 having a primary key PK of 2 are selected, among the first CDC message 411 and the third CDC message 413, an operation of the third CDC message 413, having a largest data change point in time, that is, an update (UPDATE) operation, may be recorded in an operation column of a valid CDC message having the primary key PK of 2. Subsequently, values of a first column col1 and a third column col3 may be recorded in columns of the valid CDC message having the primary key PK of 2.

In the example embodiment illustrated in FIG. 8, among fourth to sixth CDC messages 414 to 416 having a primary key PK of 3, an operation of a sixth CDC message 416 having a largest data change point in time, that is, a deletion operation, may be recorded in an operation column of a valid CDC message having a primary key PK of 3. The valid CDC message generated as described may be represented as illustrated in Table 5 below. Accordingly, among a total of seven CDC messages 410, four valid CDC messages may be generated.

TABLE 5

| Primary key (PK) | action | col1 | col2 | col3 |
|---|---|---|---|---|
| 1 | DELETE | data1 | 2025 Jan. 1 | info1 |
| 2 | UPDATE | data2 | 2025 Jan. 3 | info3 |
| 3 | DELETE | data5 | 2025 Jan. 4 | info5 |
| 4 | INSERT | data3 | 2025 Jan. 5 | info3 |

An operation of loading data into a file system managed by a target server based on valid CDC messages may be executed as described above with reference to FIG. 5. For example, data recorded in a first valid CDC message may be loaded into the file system by operation S44 in the example embodiment described with reference to FIG. 5, and a second valid CDC message may be loaded into the file system by operation S45. Operation S47 in which a DML is ignored may be performed by a third valid CDC message, and data recorded in a fourth valid CDC message may be loaded into the file system by operation S48.

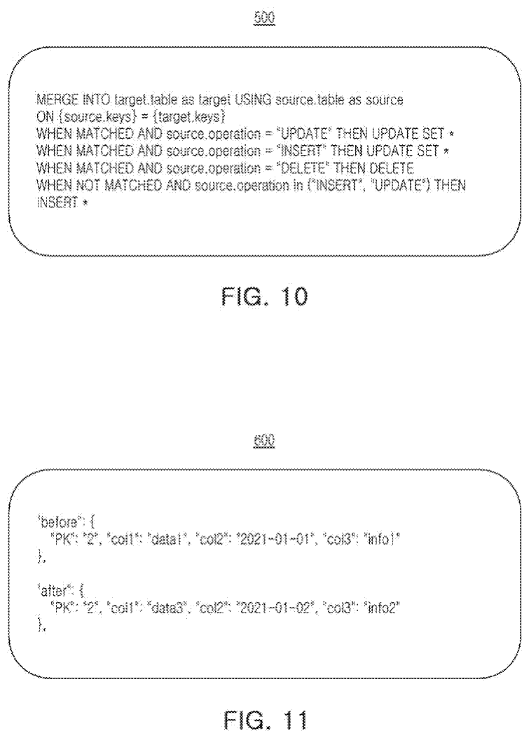

FIGS. 10 to 13 are diagrams illustrating execution of a data synchronization method for a file system according to one or more example embodiments of the present disclosure.

FIG. 10 may illustrate an SQL query 500 for loading valid CDC messages selected by an agent server into a file system. In the first line of FIG. 10, the SQL query 500 may indicate that a target table (target.table) is a table to be modified, and a source table (source.table) is a table from which data is to be retrieved. For example, the source table (source.table) may be a table including valid CDC messages selected by the agent server, and the target table (target.table) may be a table stored in a file format in a file system of a target server.

Referring again to FIG. 10, a matching condition may first be determined. In an ON clause, whether a primary key (source.keys) of the source table (source.table) matches a primary key (target.keys) of the target table (target.table) may be determined, and an operation defined in a WHEN clause may be executed depending on whether the primary key (source.keys) matches the primary key (target.keys).

First, an operation in a case in which the primary key (source.keys) of the source table (source.table) matches the primary key (target.keys) of the target table (target.table) will be described. When an operation defined in the source table (source.table) is an update (UPDATE) operation, the agent server may update data corresponding to the primary key in the target table (target.table) with data corresponding to the primary key in the source table (source.table). When the operation defined in the source table (source.table) is an insertion (INSERT) operation, the agent server may update data corresponding to the primary key in the target table (target.table) with data corresponding to the primary key in the source table (source.table). The above operations executed by a first WHEN clause and a second WHEN clause may correspond to operation S45 described above with reference to FIG. 5.

Subsequently, when the primary key (source.keys) of the source table (source.table) matches the primary key (target.keys) of the target table (target.table) and the operation defined in the source table (source.table) is a deletion (DELETE) operation, the agent server may delete data corresponding to the primary key from the target table (target.table). The operation executed by a third WHEN clause may correspond to operation S44 described above with reference to FIG. 5.

When the primary key (source.keys) of the source table (source.table) does not match the primary key (target.keys) of the target table (target.table), an operation defined by the fourth WHEN clause may be executed. When the primary key (source.keys) of the source table (source.table) does not match the primary key (target.keys) of the target table (target.table), and the operation defined in the source table (source.table) is an update (UPDATE) operation or insertion (INSERT) operation, the agent server may insert data corresponding to the primary key from the source table (source.table) into the target table (target.table). The operation according to the fourth WHEN clause may correspond to operation S48 described above with reference to FIG. 5.

When the primary key (source.keys) of the source table (source.table) does not match the primary key (target.keys) of the target table (target.table) and the operation defined in the source table (source.table) is a deletion (DELETE) operation, the agent server may not instruct any operation on the target server. The operation according to the fourth WHEN clause may correspond to operation S47 described above with reference to FIG. 5.

FIGS. 11 to 13 may diagrams illustrating valid CDC messages 600, 610, and 620 corresponding to the SQL query 500 described with reference to FIG. 10. In the example embodiments described with reference to FIGS. 11 to 13, the agent server may generate a valid CDC message in a JSON format.

First, FIG. 11 may illustrate a valid CDC message 600 generated by an agent server when a DML input to a DB server managing a source DB is an update (UPDATE) operation. Referring to FIG. 11, a primary key PK of target data on which the update (UPDATE) operation is executed by the DML may be 2. As illustrated in FIG. 11, data before the update (UPDATE) operation is executed by the DML and data after the update (UPDATE) operation is executed by the DML may be recorded in the valid CDC message 600.

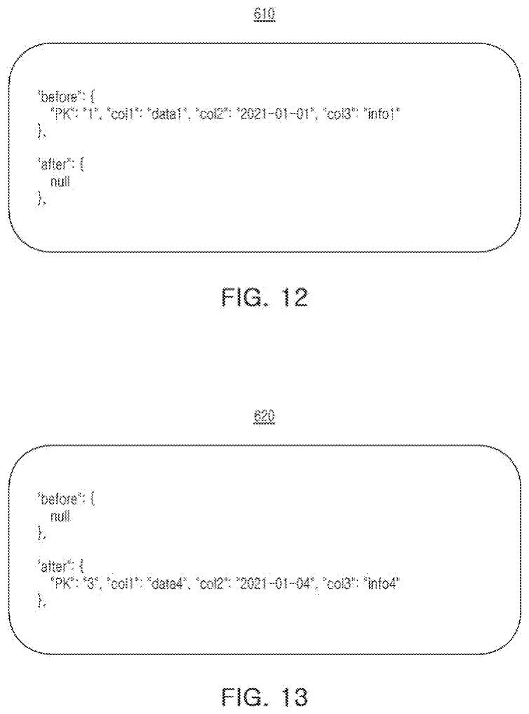

FIG. 12 may illustrate a valid CDC message 610 generated by an agent server when a DML input to a DB server managing a source DB is a deletion (DELETE) operation. Referring to FIG. 12, a primary key PK of target data on which the deletion (DELETE) operation is executed in the source DB by the DML may be 1. When data changes by the DML are reflected, all data having the primary key PK of 1 may be deleted. Accordingly, as illustrated in FIG. 12, only data before the deletion (DELETE) operation is executed by the DML may be recorded in the valid CDC message 610.

FIG. 13 may illustrate a valid CDC message 620 generated by an agent server when a DML input to a DB server managing a source DB is an insertion (INSERT) operation. Referring to FIG. 13, a primary key PK of target data to be inserted (INSERT) into the source DB by the DML may be 3. When data changes by the DML are reflected, data having the primary key PK of 3 are added, and there may be no change in data previously stored in the source DB. Accordingly, as illustrated in FIG. 13, only data after the insertion (INSERT) operation is executed by the DML may be recorded in the valid CDC message 620.

According to example embodiments of the present disclosure, a log file, generated by a DB in response to a DML input to a source DB, may be converted into a CDC message, and a valid CDC message may be selected from among the converted messages. When the valid CDC message is selected, an SQL query for loading data may be generated based on the valid CDC message, thereby allowing data to be loaded into a file system of a target server. Accordingly, a data synchronization operation, reflecting data changes occurring in the source DB into the file system rather than another DB may be executed rapidly and efficiently, and an additional load imposed on the source DB may be minimized to execute the data synchronization operation. The target server may manage data files stored in the file system in the same manner as a DB table, using a framework configured to execute an SQL query on the file system.

While example embodiments have been shown and described above, it will be apparent to those skilled in the art that modifications and variations could be made without departing from the scope of the present disclosure as defined by the appended claims.

What is claimed is:

1. A data synchronization method between a source database (DB) and a file system, the method comprising:
receiving, by a first agent server, a log file generated by a DB server managing the source DB;
generating, by the first agent server, a plurality of change data capture (CDC) messages for CDC, based on the log file;
selecting, by a second agent server, at least one CDC message, from among the plurality of CDC messages, as valid CDC message;
loading, by the second agent server, data into the file system managed by a target server, based on the at least one CDC message that is selected; and
optimizing, by the second agent server, the data loaded into the file system.

2. The data synchronization method of claim 1, wherein the first agent server is configured to generate each of the plurality of CDC messages in a JavaScript Object Notation format.

3. The data synchronization method of claim 1, wherein the first agent server is configured to receive, as the log file, a transaction log in which a change of data included in a transaction executed by the DB server is recorded, and
wherein the transaction comprises at least one data manipulation language instruction or operation.

4. The data synchronization method of claim 3, wherein the first agent server is further configured to generate the plurality of CDC messages with reference to the change of the data stored in the log file, and
wherein the second agent server is configured to sequentially arrange the plurality of CDC messages, and select the at least one CDC message, from among the plurality of CDC messages.

5. The data synchronization method of claim 4, wherein the second agent server is configured to:
sequentially arrange the plurality of CDC messages, and
select, from among two or more CDC messages corresponding to a single primary key, a latest CDC message corresponding to a latest point in time as the at least one CDC message that is selected corresponding to the single primary key.

6. The data synchronization method of claim 5, wherein the second agent server is further configured to, based on a primary key indicated by the at least one CDC message that is selected matching one of primary keys stored in the file system, instruct the target server to execute a deletion operation or an update operation with reference to the at least one CDC message that is selected.

7. The data synchronization method of claim 5, wherein the second agent server is further configured to, based on a primary key indicated by the at least one CDC message that is selected not matching each of primary keys stored in the file system, execute an insertion operation with reference to the at least one CDC message that is selected.

8. The data synchronization method of claim 1, wherein the second agent server is configured to generate, based on the at least one CDC message, a structured query language query for loading data into the file system.

9. A system comprising:
a database (DB) server configured to manage a source DB;
a target server configured to manage a file system in which one or more data changes occurring in the source DB by a data manipulation language executed by the DB server are reflected; and
an agent server configured to receive a log file generated by the DB server, generate a plurality of change data capture (CDC) messages, select at least one CDC message from the plurality of CDC messages, as valid CDC message, and generate, based on the at least one CDC message that is selected, a structured query language (SQL) query for reflecting the one or more data changes in the file system.

10. The system of claim 9, wherein the agent server is a first agent server configured to receive the log file and generate the plurality of CDC messages,
wherein the system further comprises:
a second agent server configured to select the at least one CDC message and generate the SQL query, and
wherein the first agent server and the second agent server are independent entities.

11. The system of claim 10, wherein the second agent server is further configured to collect the plurality of CDC messages generated by the first agent server during a predetermined period, and select the at least one CDC message.

12. The system of claim 9, wherein the agent server is further configured to store the log file, the plurality of CDC messages, and the at least one CDC message that is selected in the file system.

13. The system of claim 9, wherein the agent server is further configured to execute a CDC framework converting the log file into the plurality of CDC messages, and a CDC platform selecting the at least one CDC message and generating the SQL query.

14. The system of claim 9, wherein the agent server is further configured to select a plurality of CDC messages, and
wherein each selected CDC message respectively has a different primary key.

15. The system of claim 9, wherein the agent server is further configured to instruct the target server to execute a data optimization operation at a predetermined interval, and
wherein the data optimization operation comprises at least one of an operation of deleting an expired file based on metadata, an operation of merging two or more files, and an operation of compressing a file.

16. A change data capture (CDC)-based data synchronization method comprising:
receiving a log file from a source server in which one or more data changes occur in response to a data manipulation language;
converting the log file into a plurality of CDC messages;
selecting at least one CDC message, from the plurality of CDC messages, as valid CDC message; and
loading the one or more data changes into a target server based on the at least one CDC message that is selected,
wherein the source server is configured to store data in a source DB, and the target server is configured to store data in a file system.

17. The CDC-based data synchronization method of claim 16, wherein the log file has a binary format, and the plurality of CDC messages have a JavaScript Object Notation format.

18. The CDC-based data synchronization method of claim 16, further comprising:
classifying the plurality of CDC messages according to each of primary keys of the source DB; and
selecting, from the plurality of CDC messages, a latest CDC message corresponding to each of the primary keys as the at least one CDC message.

19. The CDC-based data synchronization method of claim 16, further comprising:
generating a query for loading the one or more data changes into the target server based on whether a primary key of the at least one CDC message that is selected is loaded into the target server, and an operation recorded in the at least one CDC message that is selected.

20. The CDC-based data synchronization method of claim 16, wherein the log file comprises a transaction log.
